(19) United States
(12) Patent Application Publication
(10) Pub. No.: US 2017/0070586 A1
(43) Pub. Date: Mar. 9, 2017

(54) PRESENTING AGGREGATED MEDIA DATA TO A USER

(71) Applicant: Matthew Hargraves, Grand Blanc, MI (US)

(72) Inventor: Matthew Hargraves, Grand Blanc, MI (US)

(21) Appl. No.: 15/260,340

(22) Filed: Sep. 9, 2016

Related U.S. Application Data
(60) Provisional application No. 62/215,888, filed on Sep. 9, 2015.

(51) Int. Cl. H04L 29/08; H04L 12/911

(52) U.S. Cl. CPC H04L 67/26; H04L 67/02; H04L 67/306; H04L 67/10; H04L 67/34; H04L 47/70

(57) ABSTRACT

A system and a method of providing aggregated media data to a user is disclosed. The method includes the steps of: associating an media identifier of an object entity with an account of the user at a home server; receiving media data from a media server at the home server in response to the object entity providing a communication via the media server, wherein the media data is associated with the communication of the object entity and wherein the object entity has a media server account; and providing the media data in an aggregated format to the user via a client device.

This application claims the benefit of U.S. Provisional Patent Application 62/215,888, filed Sep. 9, 2015.

### TECHNICAL FIELD

The present disclosure relates to aggregating media data and presenting the media data to a user via a client device.

### BACKGROUND

With a general increase in social media traffic, users of social media find it increasingly difficult to track or follow various people/entities which interest them. For example, as new social media websites and new mobile device applications become available, the people/entities which a user may ‘follow’ also may increase (e.g., as each followed person/entity may create additional social media account(s) at newer social media website(s)). Checking these newer—as well as more established—social media sites to learn about the so-called ‘followed’ people/entities can become too time-consuming for the user.

Thus, there is a need to aggregate media data pertaining to the various people/entities which are followed by the user.

### SUMMARY

According to an embodiment of the present disclosure, there is provided a method of providing aggregated media data to a user. The method includes the steps of: associating an media identifier of an object entity with an account of the user at a home server; receiving media data from a media server at the home server in response to the object entity providing a communication via the media server, wherein the media data is associated with the communication of the object entity and wherein the object entity has a media server account; and providing the media data in an aggregated format to the user via a client device.

According to another embodiment of the present disclosure, there is provided a non-transitory computer readable medium having data stored therein that includes application software executable by a mobile device, the software having instructions, the instructions including: receiving media data at the mobile device from a media server via a home server in response to the object entity providing a communication via the media server, wherein the media data is associated with the communication of the object entity and wherein the object entity has a media server account; and displaying the media data on the mobile device.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of an object entity activity aggregation system that is capable of utilizing the method disclosed herein;

FIGS. 2A-2B are flow diagrams depicting a method of providing media data to a client device using the system shown in FIG. 1;

FIG. 3 illustrates a client device displaying aggregated social media; and

FIG. 4 illustrates a schematic diagram of a subscriber-generated social media feed which is provided to another subscriber.

### DETAILED DESCRIPTION OF THE ILLUSTRATED EMBODIMENT(S)

An object entity activity aggregation system is described below that enables a user via a client device to view media activity (e.g., social media activity) of an object entity after the object entity uploads to a social media platform a posting, message, hyperlink, etc. For example, the object entity may be a real or fictional person or group of people, a business, organization, etc., and the object entity's recent social media activity will appear on the user's client device in an aggregated format. In this manner, the user may be capable of viewing all media activity of a particular object entity (e.g., across multiple social media platforms). The user is not limited to tracking the media activity of a single object entity either. For example, the user can view aggregated social media activity of multiple object entities based on registration parameters defined by the user. In this manner, the user may view a consolidation of social media entries by the object entity(ies) over a multitude of social media platforms—e.g., all recent object entity uploads to Facebook™, Twitter™, LinkedIn™, etc. As will be described in greater detail below, the activity aggregation system comprises a home server, at least one media server, and a client device associated with the user. In carrying out the methods described below, the home server communicates with the media server to receive updates pertaining to the object entity, and then the home server communicates with the client device to notify the user.

### Communication System

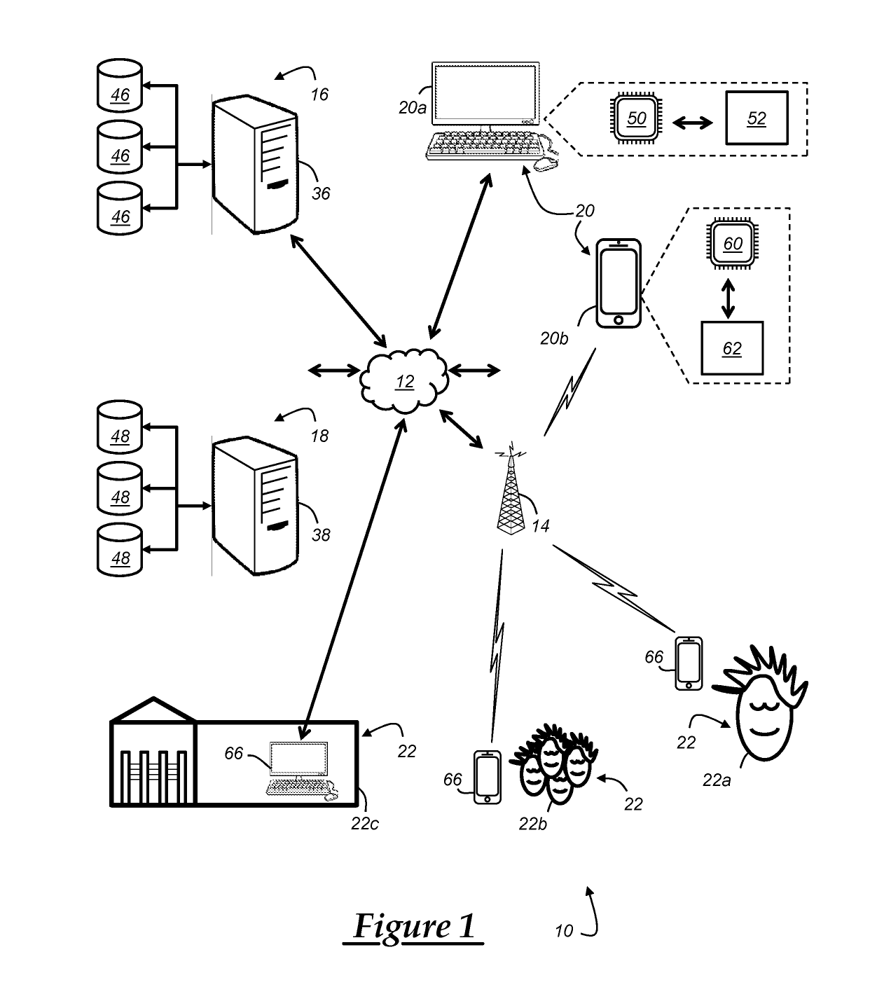

FIG. 1 illustrates an object entity activity aggregation system 10 that includes a land network system 12, wireless communication infrastructure 14, a home server 16, a media server 18, two exemplary client devices 20, and several persons or object entities 22. The servers 16, 18, the client devices 20, and the object entities 22 may communicate with one another using land network system 12, wireless communication infrastructure 14, or both. Land network system 12 may be a land-based telecommunications network that comprises one or more interconnected landline telephones and is connected to wireless communication infrastructure 14. Land network system 12 may include a public switched telephone network (PSTN) such as that used to provide hardwired telephony, packet-switched data communications, and the internet infrastructure. One or more segments of land network system 12 could be implemented through the use of a standard wired network, a fiber or other optical network, a cable network, power lines, other wireless networks such as wireless local area networks (WLANs), or networks providing broadband wireless access (BWA), or any combination thereof. Other aspects of land network systems 12, as well as their implementation and use, will be appreciated by skilled artisans and will therefore not be explained further here.

Wireless communication infrastructure 14 may be a cellular telephone system that includes a plurality of cell towers operable according to any suitable cellular communication technology (e.g., AMPS, CDMA, GSM/GPRS, LTE, etc.). Thus for example in GSM systems, infrastructure includes base station controllers (BSCs), mobile switching centers (MSCs), serving GPRS support nodes (SGSNs), home location registers (HLR), etc. Or in LTE systems, infrastructure includes enodeB, mobility management entities (MMEs), home subscriber servers (HSSs), serving gateways (SGWs), packet gateways (PGWs), etc. These are only meant as examples of wireless communication infrastructure 14; other examples also exist (e.g., satellite communication and the like). Further, the illustrated wireless communication infrastructure 14 may include use of multiple communication technologies as well. As shown in FIG. 1, infrastructure 14 may be connected to land network system 12 and allow communications between home server 16, media server 18, the client devices 20, and the object entities 22.

Both home server 16 and media server 18 may include similar structure; however, the hardware, software, etc. may be configured for different and respective purposes. For example, the servers 16, 18 each can be any one of a number of remotely located computers accessible via a private or public network such as the internet. Servers 16, 18 may include one or more processors or processing centers 36, 38 (respectively) and be coupled to one or more databases 46, 48 (respectively) (several databases are shown; however, this is not required). Databases 46, 48 may include storage devices that comprise any suitable non-transitory computer usable or readable medium; e.g., including but not limited to RAM (random access memory), ROM (read only memory), EPROM (erasable, programmable ROM), EEPROM (electrically erasable, programmable ROM), and/or magnetic or optical disks or tapes. Processors 36, 38 can be any type of device capable of processing electronic instructions which may be stored at the processors 36, 38 (respectively), the database(s) 46, 48 (respectively), or both. Non-limiting examples of processors 36, 38 include microprocessors, microcontrollers, host processors, controllers, and application specific integrated circuits (ASICs), just to name a few examples.

In some embodiments, each processing center 36, 38 may be configured for dedicated operations. For example, home server 16 may be configured in hardware, software, or both to interact with client devices 20 (e.g., receiving user registration data and object entity parameters), as well as with media server 18. Media server 18 may be configured in hardware, software, or both to interact with object entities 22 (e.g., receiving and publishing social media postings, messages, hyperlinks, etc.), as well as to communicate with home server 16. This will be explained in greater detail below. Thus for example, servers 16, 18 each may include any special-purpose computer system dedicated to facilitating at least a portion of the method(s) described herein. Regardless of the nature, type, or characteristics of the processors, the processors 36, 38 respectively may execute various types of digitally-stored instructions, such as software or firmware programs stored within the processors 36, 38 and/or in the databases 46, 48, thereby enabling the centers 36, 38 respectively to perform a wide variety of tasks, as well as execute programs and/or process data to carry out at least a part of the method discussed herein.

In FIG. 1, one home server 16 is illustrated and one media server 18 is illustrated. It should be appreciated that the one home server 16 can be representative of any number of physical devices associated with one another to carry out the methods described herein. For example, the home server 16 may have connected or associated servers or computers in various geographical locations; however, the servers 16 may operate as a single entity. There may be more than one media server 18 as well; however, the media servers 18 may or may not be associated with one another. Consider an example describing social media entities Facebook™ and Twitter™. Facebook™ may have a multitude of Facebook media servers 18, each associated with one another via private communication link(s). Similarly, Twitter™ also may have a multitude of Twitter media servers 18, each associated with one another via private communication link(s). However, while the servers of Facebook™ and the servers of Twitter™ may communicate with one another, they may not be associated with one another (e.g., part of a common intranet, private network, or the like).

Client devices 20 may include any suitable device for transmitting and/or sending electronic data; client devices 20 include static devices 20a and mobile devices 20b capable of wired communication, wireless communication, or any combination thereof. For example, static device 20a could be a personal or desktop computer (PC) capable of accessing and enabling user-interaction with the internet (with or without executable software) or via a website portal. Such static devices may be any analog, digital, neural, etc. computing device that includes hardware, software, and/or firmware suitable for carrying out at least a portion of the methods described herein. At least some of the static client devices 20a include one or more processors 50 (e.g., microprocessor(s)), memory 52, and any other suitable electronics). Other non-limiting examples of static devices 20a also include mainframe computers, minicomputers, microcomputers, and even supercomputers, just to name a few examples.

Mobile client device 20b includes any portable device which may be used for wired and/or wireless communication and should be broadly construed as well. Mobile device hardware may include one or more input and output interfaces—e.g., including a display, a keyboard, touch screen, pushbutton(s), one or more processors 60, and memory 62 (e.g., a non-transitory computer readable medium). Processor(s) 60 and memory 62 may be similar to processor 50 and memory 52 described above; however, here the memory 62 may store different instructions (and the processor(s) 60 may execute different instructions) to carry out at least part of the method described herein.

In at least on embodiment, mobile device 20b includes application software for receiving communications from the home server 16 and displaying the social media activity of one or more object entities 22, according to at least a portion of the method described herein. The application software may include instructions enabling a user of the mobile device 20b to subscribe or register with home server 16 thereby creating an account and defining object entity parameters which can both identify the object entity, as well as tailor the social media activity displayed to the user. The application software may utilize any suitable data transmission technique; e.g., via a voice or data call or e.g., by transmitting packet data that includes textual data and/or multimedia data, electronic mail (e-mail), short messaging service (e.g., SMS or texts), just to name a few non-limiting examples. In at least one implementation, the application software is saved in a non-transitory medium of home server database(s) 46 and downloadable via an internet connection to the client device 20 (e.g., via the land network system 12, the wireless communication infrastructure 14, or both). For example, in at least one implementation, application software may be provided from the home server 16 to a third party provider (not shown) (e.g., an Amazon™, Apple™, etc. App Store or the like); thereafter, the software may be downloadable via the third party provider and thereafter installed in client device memory 62 and executable by client device processor(s) 60.

In some wireless implementations, mobile device 20b may be used to make cellular telephone calls across a wide geographic area using wireless communication infrastructure 14. In other implementations, mobile devices 20b (and/or static devices 20a) may communicate according to a number of short range wireless communication protocols (SRWC); SRWC is intended to be construed broadly and may include one or more suitable wireless protocols such as but not limited to: any Wi-Fi standard (e.g., IEEE 802.11); Wi-Fi Direct, Bluetooth, Digital Living Network Alliance (DLNA), or other suitable peer-to-peer standard; wireless infrared transmission; WiMAX; ZigBee™; and/or various combinations thereof. And of course, some mobile devices 20b may communicate using both cellular and SRWC communication, as will be appreciated by skilled artisans. In addition, some mobile devices 20b may be couplable to wired connections as well; e.g., an Ethernet, USB, or like connection providing internet connectivity or providing access to a website portal.

Non-limiting examples of the mobile device 20b include a cellular telephone, a personal digital assistant (PDA), a Smart phone, a personal laptop computer or tablet computer having two-way communication capabilities, a netbook computer, a notebook computer, or any suitable combinations thereof.

As used herein, each object entity 22 may be one of a real or fictional person (e.g., 22a) (or a real or fictitious group of people 22b), an entity providing at least one of goods or services (e.g., a business) (e.g., 22c), or any other entity such as a cooperative, an association, a collective group, or an organization. According to one implementation, each object entity 22 has at least one social media account with at least one media server 18. In FIG. 1, the object entities 22 may use any suitable communication device 66 to communicate with land network system 12, wireless communication infrastructure 14, or any combination thereof. In at least some embodiments, the communication devices 66 may be similar to the client devices 20, described above. Namely, a static or mobile communication device connected to the media server 18 (e.g., via the land network 12 or wireless communication infrastructure 14, just to name a couple of examples).

### Method

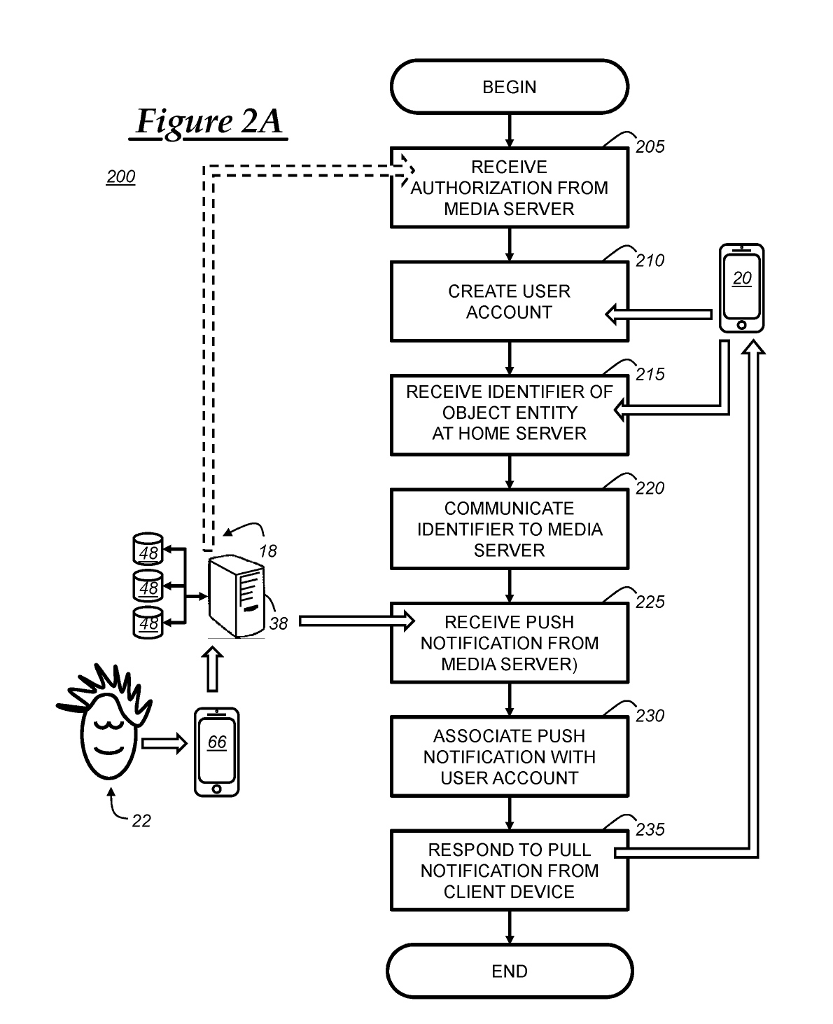

Turning now to FIGS. 2A and 2B, there is shown an embodiment of a method 200 of using the activity aggregation system 10 described above. The illustration shows a mobile device; however, it should be appreciated that the device 20 can be one or more static devices 20a, one or more mobile devices 20b, or a combination thereof. The method 200 begins with step 205 which includes the home server 16 receiving authorization and/or agreement from the media server 18 to receive social media data therefrom and publish (or republish) at least a portion of that media data. The received social media data includes information associated with public communications of users of an associated social media website; more specifically, public communications of object entities 22. Public communications include user statuses, comments, updates, tweets, or like postings, user audio and/or visual data (e.g., photos, videos, audio clips, etc.), user blog articles, and any other suitable user content (including shared links or hyperlinks to websites, audio, video, images, etc.). Public communications do not include: private messages from the object entity to another user account; private messages from another user account to the object entity; any status, comment, update, tweet, or like posting intended only for a select group of other user accounts (e.g., a subset of all the object entity's ‘friends,’ ‘connections,’‘followers,’ etc.); and any other non-public user audio and/or visual data (e.g., photos, videos, audio clips, etc.) and/or non-public user content (including shared links or hyperlinks to websites, audio, video, images, etc.). The home server 16 may receive such authorization from one or more media servers 18, and each media server may be associated with a different social media platform. For example, media server 18 may be associated with the social media website Facebook™; and other media servers (not shown) may be associated with different social media websites (e.g., Twitter™, Instagram™, LinkedIn™, YouTube™, VivoWeb™, MySpace™, just to name a few non-limiting examples). Following step 205, method 200 proceeds to step 210.

In step 210, the home server 16 creates an account for a user. Skilled artisans will appreciate various ways in which the home server 16 may enable users to create an account. For example, an account may be established by the user (e.g., now a subscriber to the services provided by the home server 16) after the subscriber downloads a software application on a mobile device or personal computer (e.g., onto client device 20) and executes the software, or after the subscriber accesses a web portal (e.g., via an internet browser on client device 20), or by any other suitable means. Regardless of the interface between the subscriber and the home server 16, the home server may receive registration data from the subscriber in order to create the account. FIG. 2B illustrates one embodiment of step 210 (illustrated as step 210a). In step 210a, home server 16 receives and stores registration data, which may include one or more subscriber identifiers (e.g., a name of the subscriber, home server username, etc.), one or more subscriber characteristics (e.g., age, gender, etc.), and one or more subscriber contact elements (e.g., a subscriber email, a subscriber phone number, etc.), just to name a few examples. Other implementations are also possible. Next, the method may proceed to step 215.

In step 215, home server 16 may receive an identifier of at least one object entity 22 from the subscriber (e.g., via client device 20). The identifier may be stored and/or used by the media server 18 (e.g., it may be an object entity name or handle (e.g., a username or the like)). As previously discussed, the object entity 22 could be a real or fictional person (or a real or fictitious group of people), a business entity dealing in goods, services, or both, or any cooperative, association, collective group, or organization, just to cite a few examples. The identifier may include one or more letters, numbers, symbols, characters, or any combination thereof; non-limiting examples of the identifier include an actual or legal name of a person, business, etc., a username or user handle which the object entity uses in association with at least one social media website, or the like. In some instances, the object entity may use different identifiers with different media servers (e.g., one username for Facebook™ and another username for Twitter™) or may be associated with two different identifiers on a single social media platform. In these instances, it is contemplated that the media server 18 provides to the home server 16 any pertinent identifier information in at least some embodiments; e.g., in accordance with the authorization received in step 205. This is discussed in greater detail below. In addition, as will be discussed below, this identifier may be used in communications between the home and media servers 16, 18 (e.g., to provide a subscriber via client device 20 an update of the object entity's activities, as well as carry out other steps of the method(s) described below).

FIG. 2B illustrates additional embodiments of step 215 (e.g., 215a and 215b). In step 215a, the one or more received identifiers may be stored in memory 46 of home server 16 (alternatively or in addition thereto, the identifier(s) could be stored on the client device 20). Step 215b may be used separately or in combination with step 215a. In step 215b, one or more narrowing parameters may be received and/or stored in memory 46 as well. Narrowing parameters may be used to limit the amount of object entity data ultimately provided to the client device 20 and subscriber. For example, the subscriber may not desire to see everything (e.g., all public content) that the object entity posts on or uploads to a social media platform, or for example, the subscriber may desire to see everything the object entity uploads to one media server (e.g., Facebook™), but only a portion of the what the object entity uploads to another media server (e.g., Twitter™). Thus, narrowing parameters may serve a filtering function—limiting the volume and type of information that the subscriber receives regarding the targeted object entity 22. Non-limiting examples of narrowing parameters are illustrated; e.g., category 215b(1) illustrates that one narrowing parameter may identify a particular social media website or platform (or a type of social media website or platform (e.g., messaging, images, video, etc.)). Category 215b(2) illustrates that another narrowing parameter may identify location criteria of the object entity (e.g., a world region, country, state or province, county, city or township, a street or district, a venue, etc.) Category 215b(3) illustrates that another narrowing parameter may identify time and/or date criteria (e.g., a time range, a date range, uploads after a specified time or date or leading up to a particular time and/or date, just to cite a few non-limiting examples). And category 215b(4) illustrates that the narrowing parameters may pertain to the subject matter criteria of the object entity's upload. For example, where the object entity is a pop star or musical group, the narrowing parameters may be used to identify only girlfriends or boyfriends of band members or only touring information, or only live public appearances (these of course are merely examples related to the pop music industry; additional subject matter categories are myriad). Further, additional narrowing parameter categories are possible as well; the four shown in FIG. 2B are only intended to be illustrative.

Thus, as will be explained in greater detail below, without narrowing parameters, any and/or all (or virtually all) public communications of the object entity 22 may be published to the subscriber via the subscriber's account at the home server 16. And with one or more narrowing parameters, some public communications by the object entity may be filtered or removed from publication to the subscriber, in accordance with the subscriber-selectable narrowing parameters. Public communications can include those communications viewable by anyone (e.g., anyone with a media server account). In some instances, they also may include communications generally viewable and/or receivable by those ‘connected to’ the object entity 22, ‘friends with’ the object entity 22, ‘following’ the object entity 22, etc. however, public communications exclude so-called private communications which are communications by the object entity 22 directly to another person or user of the respective social media platform (or to a select group of other similarly-situated users or an enumerated group of selected and similarly-situated users). In some embodiments, private communications may be used as well; however, in at least one embodiment, all object entity communications used are public.

It should be appreciated that the subscriber—using the home server 16 and/or client device software or a web portal—may look-up the identifier(s), search a database of identifiers (e.g., database 46), or the identifier(s) may be suggested to the subscriber when the subscriber at least partially provides some identifying information. In one example, media server 18 may provide object entity identifiers for one or more of its account users to the home server 16. And as a result, the home server 16 may provide and/or present these identifiers and information associated with each of these identifiers for display on the client devices 20 (e.g., via a mobile software application, web portal, etc.). Then, subscribers may select the object entity identifier or any other suitable indicia representing the identity of the entity (that is associated with the object entity identifier) from among a plurality of choices. For example, the subscriber may select actual name of a celebrity or the like or may select a username of the celebrity (e.g., used by that celebrity on a particular social media platform). The subscriber may perform step 215 (and 215a and/or 215b) using the client device 20 which then communicates this information to the home server 16 in step 220.

Returning to FIG. 2A, in step 220, the identifier(s) associated with the object entity may be communicated to the media server 18 (or in the case of multiple media servers, to the respective media servers). In addition, any narrowing parameters identified or selected by the subscriber also could be communicated to the respective media server(s). In this manner, the media server 18 may communicate information pertaining to the object entity to the home server 16, as suitably desirable. Step 225 may follow.

In step 225, the home server 16 and media server 18 communicate with one another—e.g., media data associated with one or more object entities 22 may be sent from the media server 18 to the home server 16. For example, the media server 18 may provide media data associated with at least one public communication upload of the object entity 22 to the home server 16. This media data may pertain to an object entity 22 which was followed or selected by the subscriber (e.g., in the subscriber registration steps above). In at least one implementation, the media server 18 sends a push notification to the home server 16 in accordance with the authorization agreement of step 205. Further, this push notification may be in response to receiving the home server's communication in step 220—i.e., in response to at least one subscriber of the home server 16 desiring to receive the particular target object entity's public communications via the service provided by the home server 16. Of course, this is merely an example; and other implementations also exist. For example, the home server 16 could query the media server 18 and the media server may respond accordingly (e.g., a pull notification from the home server 16), or the media server 18 (in any other suitable manner) could send data to the home server 16 regarding one or more public communications/uploads of the object entity 22. These also are only examples. In the instance a push notification is used by the media server 18, the home server 16 may be able to receive information quickly regarding the object entity's public communication upload. For example, the media server 18 associated with the social media account of the object entity is first to recognize that the object entity 22 has made the public communication upload and is therefore in the unique position to quickly alert the home server 16 of the public communication upload. Following step 225, the method may proceed to step 230.

In step 230, the communication between the home and media servers 16, 18 may be associated with the subscriber's account using processor(s) 36. For example, the public communication upload of the object entity 22 may be associated with the subscriber account in which the object entity is identified. Where multiple subscribers are associated with the home server 16 and where some of these subscribers follow the same object entity 22, the home server may associate the public communication upload with more than one subscriber account (e.g., each respective or different subscriber or subscriber account). Step 235 may follow.

In step 235, the home server 16 may communicate with the client device 20 (associated with the subscriber) so that the subscriber may receive and view the respective media data (e.g., the public communication upload) via his or her one or more client devices 20. This communication may occur in a variety of ways as well. In one embodiment, the client device 20 provides a pull notification to the home server 16 and the home server provides information about the object entity's public communication upload (as well as any other public communication by other object entities 22 which the subscriber may be following). When the client device 20 receives the communication from the home server 16, the subscriber may view the media data associated with the public communication(s) on the device 20 (e.g., on the mobile device display, personal computer screen, etc.). Thereafter, method 200 may end.

This method, or portions of it, may be repeated. For example, the object entity 22 may upload another public communication and steps 225-235 may be repeated so that the subscriber receives additional media data (e.g., new public communication uploads) based on the object entity's online activity. Or for example, the subscriber may update or change object entities 22 which the subscriber follows. This may include the subscriber adding or deleting object entities 22 associated with his or her subscriber account. In some embodiments, the subscriber may add or delete narrowing parameters (such as those discussed in step 215b). Or the subscriber may even create subscriber-defined narrowing parameters and apply those to his or her subscriber account.

Communications between the home and media servers 16, 18 may be repeated (e.g., multiple push and/or pull notifications) as desired. In addition, even after the subscriber(s) begin receiving public communications associated with one or more targeted object entities 22, the home server 16 may add or delete media servers (e.g., such as server 18). For example, home server 16 may add additional media servers upon the creation and public access to a new social media platform (or may delete social media platforms which have become extinct or are no longer desirable to utilize).

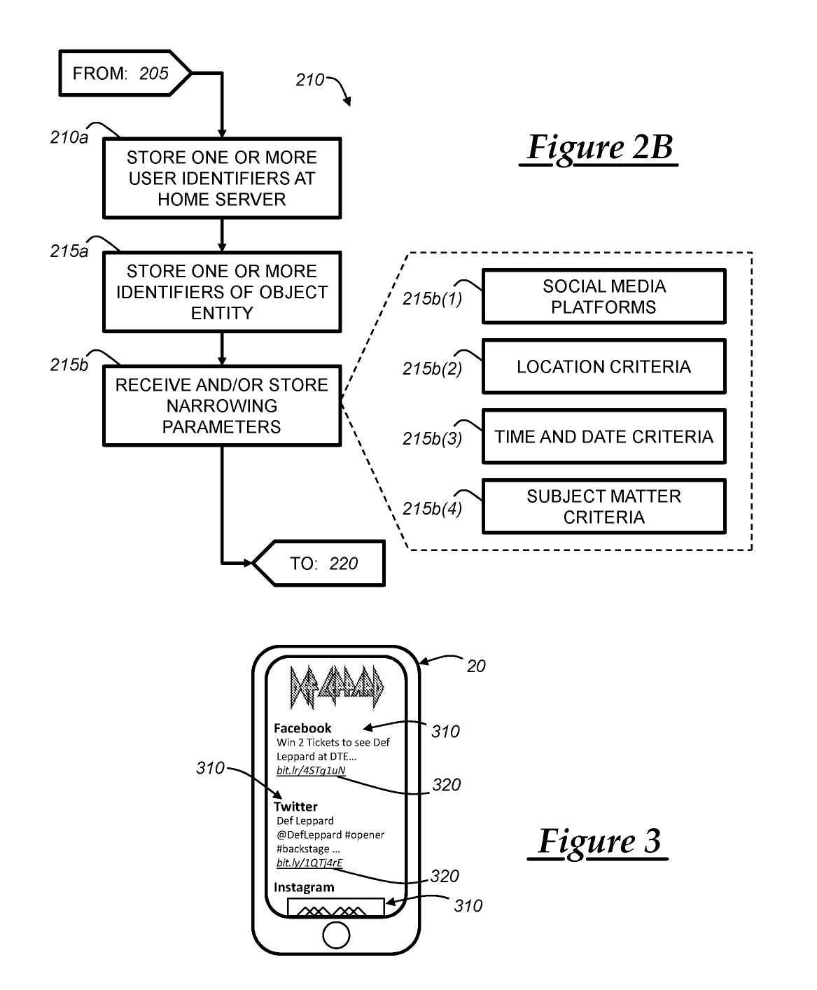

It should be appreciated that in at least one implementation, the subscriber views only a portion of the public communication upload by the object entity 22 on the client device 20. FIG. 3 illustrates one client device 20 displaying an aggregated media data format pertaining to one exemplary object entity (e.g., Def Leppard™). Here, the object entity 22 previously provided several public communication uploads (e.g., postings, tweets, images, etc.) to several exemplary social media platforms (e.g., Facebook™, Twitter™, Instagram™), the media server 18 provided the home server 16 with media data associated with the public communication uploads, and then the home server 16 provided the media data to the client device 20 in the aggregated format (which is illustrated in FIG. 3). The client device display (FIG. 3) also illustrates a teaser or preview portion 310 of the media data (or more specifically a teaser of the public communication upload). The length or volume of this portion 310 may be predetermined in the authorization step 205 (e.g., agreed upon between the entities associated with the home and media servers 16, 18). Other parameters of the teaser 310 may be predetermined as well (e.g., the font style, the font size, the usage of social media platform trademarks, the content of any graphics, images, photos, etc. provided by the media server 18 or reproduced by the home server 16, the size or resolution of such graphics, images, photos, etc. provided by the media server 18 or reproduced by the home server 16, just to name a few non-limiting examples). The teaser 310 also could be limited by the quantity of data, number of characters, quantity of pixels, or any other suitable manner of limiting the size of the public communication upload provided by the media server 18 to the home server 16 (and ultimately to the subscriber via client device 20). In one embodiment, the teaser is provided by the media server 18 to the home server 16. In another embodiment, the teaser 310 is determined by the home server 16 (e.g., extracted from a larger quantity of data provided by the media server 18). Further, teasers 310 may have one or more hyperlinks 320 redirecting subscribers to other websites or the like. In this manner, the client device 20 may enable the subscriber to select or ‘click’ on the teaser 310 and be re-directed to the media server 18 (or any other suitable website or internet location).

Server traffic volume can be a measure of value and competitive advantage in the social media industry; i.e., the greater the volume of user traffic, the more advertisers desire to advertise and the more such advertisers are willing pay for advertisements and the like. Greater quantities of ads and greater price per advertisement equates to higher profits for the owner of the social media platform. Other advantages also may exist. Thus, when the selected hyperlink 320 re-directs the subscriber of the client device 20 from the home server 16 to the media server 18 which provided the public communication upload (in the first place), the media server 18 may receive additional traffic, and this may be desirable to the media server 18. Thus, when the home server 16 provides aggregated information pertaining to a particular object entity 22, the home server 16 may not direct traffic away from media server 18, but rather to it (e.g., providing incentive for the media server 18 to agree to push social media data to the home server (per step 205)).

The previous discussion generally was explained in the context of a single subscriber using one or more client devices 20. However, it is contemplated that a number of subscribers each may use the activity aggregation system 10 described above in a similar manner. Consequently, an even greater volume of traffic may be driven to the media server(s) 18 as a result of a plurality of subscribers using home server 16 and the application software associated therewith.

Other embodiments also exist. For example, the subscriber may receive the aggregated media data pertaining to the subscriber-selected object entities 22 on more than one client device 20. For example, since the subscriber has an account with the home server 16, in at least one embodiment, the subscriber may view the same or similar object entity information on one client device 20 as another (e.g., the same information on a desktop computer as a mobile device).

In another embodiment, the media data may be aggregated or compiled with other media data previously received by the home server. Using the example shown in FIG. 3, the home server 16 may provide data pertaining to Def Leppard™ over the past several hours, past several days, past several weeks, etc. In other words, aggregating media data does not necessarily imply that all public communication uploads by the object entity were recent or at (or near) the same time. However, in at least one implementation, the newest media data (e.g., or portions 310 may be displayed on client device 20 chronologically—e.g., newest to oldest, or vice-versa).

For example, the implementation described above pertained to social media content. In at least one implementation, other media data is used. For example, live online activities, such as Periscope™ feeds, Meercat™ feeds, Twitch™ feeds, YouTube™ video posts, blogging activities, forum postings, broadcast news articles, postings, or videos (e.g., NY Times™ or Fox News™), or any other user-specific online (internet) activities. Again, these are merely examples as well and are intended to illustrate types of media which may be each associated with one or more different media servers (e.g., such as servers 18).

Still other embodiments are contemplated. In one embodiment, a target object entity may have a subscriber account with the home server 16 as well. The object entity—using his or her subscriber account—may elect or choose to authenticate with the home server 16 one or more of his or her social media platform accounts. Thus, subscribers which receive the public communications and media data (or activity) posted, uploaded, etc. by the object entity will have verification that the object entity information is legitimate—i.e., the source of the public communications is legitimate. To use an example, if Celebrity A (the object entity) has a Facebook™ account, a Twitter™ account, and a subscriber account with the home server 16, then Celebrity A may authenticate the Facebook™ account and the Twitter™ account at the home server 16 so that subscribers who follow (or receive the public communications of) Celebrity A, will know that public communications via the Facebook™ and Twitter™ accounts are valid or legitimate. Of course, Celebrity A may elect to not authenticate one or more social media platform accounts (or any of his/her social media platform accounts).

Authentication at the home server 16 may include using a communication device 66 (e.g., a client device) to select or configure a setting for social media platform accounts with which the object entity is associated. In at least one embodiment, authentication may include using social media platform account credentials (e.g., known to the object entity). For example, via the web portal (on a static device 20a) or via the software application (on a mobile device 20b), the object entity may be presented with an opportunity to enter or provide his/her credentials (or an agent of the object entity may do so) in order to authenticate one or more of the object entity's social media platform accounts.

In addition, the authentication by an object entity may be requested or solicited. For example, when an object entity is followed by a home server subscriber, the home server 16 may send a message or notification to the object entity requesting the object entity perform the authentication described above. Or for example, after the object entity has a threshold quantity of followers (subscribers), then the home server 16 may send the request for authentication. Of course, the authentication request is not required in all embodiments.

It should be appreciated that authentication includes verifying that the public communications of the object entity are in fact communications associated with the account holder at the media server 18 from whence they originated. However, it does not ensure that the account holder is in fact who he (she/it) represents himself (herself/itself) to be. For example, if an Elvis Presley in Florida represents himself as “The King” online by creating an account with Facebook™ and authenticates this Facebook™ account with the home server 16, this does not imply that Elvis Presley of Florida is in fact the famous singer/actor Elvis Presley. Instead, it validates that the Elvis Presley of Florida in fact posted, uploaded, etc. a public communication with an associated Facebook™ account and that the publication provided via the home server 16 is in fact the same communication provided to the Facebook™ account (or at least a part thereof). Authentication techniques are generally known in the art and will not be described in detail here.

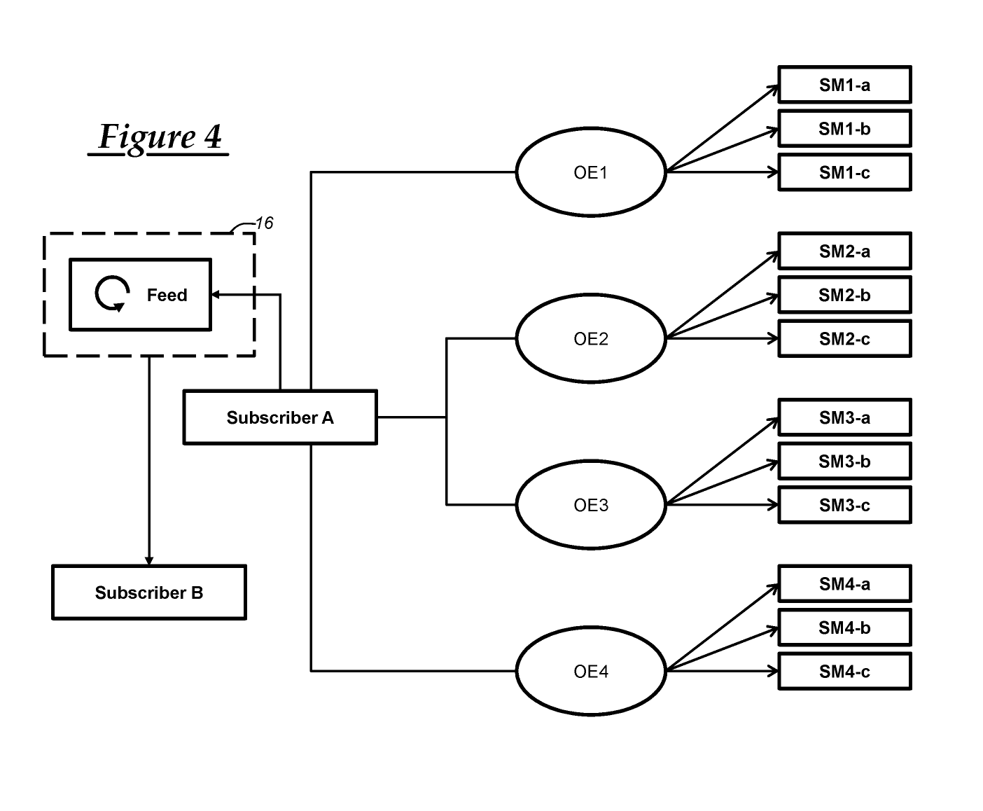

In another embodiment, the subscriber account may be used to generate and share one or more subscriber-managed feeds. Recall for example how the subscriber can follow or track the public media communications of one or more object entities. These can be shared with other subscribers of the home server 16 as well. Consider for example the object entities (OEs) followed by an exemplary subscriber A (see FIG. 4): OE1 (having social media accounts SM1-a, SM1-b, SM1-c, etc.), OE2 (having social media accounts SM2-a, SM2-b, SM2-c, etc.), OE3 (having social media accounts SM3-a, SM3-b, SM3-c, etc.), and OE4 (having social media accounts SM4-a, SM4-b, SM4-c, etc.). For illustrative purposes, assume that subscriber A receives all public communications from each of the object entities OE1, OE2, OE3, and OE4 (e.g., no filtering). Subscriber A can elect or choose to share this information as a feed created by and managed by subscriber A. Thus, another subscriber (subscriber B) may subscribe to and/or receive this same feed via subscriber B's account with home server 16. A respective client device of subscriber B may receive the feed via a pull notification (e.g., from the home server 16), as described above. For example, once a setting of subscriber B is configured at the home server 16 indicating a desire to follow the feed, whenever subscriber B's client device sends a pull notification to the home server 16, the feed may be delivered to subscriber B's client device(s). Alternatively, subscriber B's client device may receive the feed in any other suitable manner—e.g., such as any of the implementations described above with respect to FIGS. 2A-2B or the like.

One or more of the various embodiments described herein may be used in combination with one another. One non-limiting example includes the two previous embodiments. For example, the feed created and managed by subscriber A (and received by subscriber B) could include a combination of authenticated and non-authenticated social media platform accounts (associated with the object entities OE1, OE2, OE3, and OE4). For example, social media accounts SM1-a and SM1-b (of OE1) could be authenticated by OE1, while social media account SM1-c (of OE1) is not authenticated.

Thus, there has been described an activity aggregation system pertaining to the public communication uploads of an object entity. The object entity may take a variety of forms (e.g., a person or group of people—real or fictitious), a business entity, or any other suitable organization, association, collective group, etc. The system enables interaction between a media server (e.g., providing media content such as social media content) and a home server. The home server is configured to receive communications from the media server when an object entity uploads content to the media server; in turn, the home server notifies one or more subscribers of this upload. The subscribers, using their respective client devices, may view at least a portion of the upload. In some instances, the subscribers may be re-directed to the media server if a selection is made with the client device. At least one embodiment, the activity aggregation system includes providing a software application enabling a subscriber via a computer or mobile device to interact with the home server.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of providing aggregated media data to a user, comprising the steps of:
associating an media identifier of an object entity with an account of the user at a home server;
receiving media data from a media server at the home server in response to the object entity providing a communication via the media server, wherein the media data is associated with the communication of the object entity and wherein the object entity has a media server account; and
providing the media data in an aggregated format to the user via a client device.

2. The method of claim 1, further comprising:
establishing the account for the user at the home server prior to the associating step, wherein establishing the account comprises:
receiving registration data for the user; and
storing in memory of the home server the media identifier of the object entity.

3. The method of claim 2, wherein the registration data further comprises receiving narrowing parameters, wherein the narrowing parameters limit the amount of object entity information provided to the user in the providing step.

4. The method of claim 1, wherein the media server is associated with a social media platform, wherein the communication by the object entity is a social media communication.

5. The method of claim 4, wherein the social media communication includes at least one of the following: a status, a comment, an update, a tweet, a posting, audio data, visual data, audio-visual data, a blog article, or a hyperlink.

6. The method of claim 1, wherein the object entity includes one of a real or fictional person, a real or fictional group of persons, an entity providing at least one of goods or services, a cooperative, an association, a collective group, or an organization.

7. The method of claim 1, further comprising receiving at the home server an authorization from the media server to publish at least a portion of the media data associated with the object entity.

8. The method of claim 1, wherein the media data received from the media server to the home server is a push notification.

9. The method of claim 1, wherein the providing step further comprises receiving a pull notification from the client device.

10. The method of claim 1, wherein the providing step further comprises providing a teaser to the client device, wherein the teaser is associated with a portion of the communication provided by the object entity.

11. The method of claim 1, wherein the providing step further comprises providing a hyperlink in the media data, wherein the hyperlink directs the user from a connection with the home server to a connection with the media server.

12. The home server, comprising:
one or more processors; and
a non-transitory computer readable medium having instructions stored therein executable by the one or more processors, the instructions being configured to perform the steps of claim 1.

13. A non-transitory computer readable medium having data stored therein that includes application software executable by a mobile device, the software having instructions, the instructions including:
receiving media data at the mobile device from a media server via a home server in response to the object entity providing a communication via the media server, wherein the media data is associated with the communication of the object entity and wherein the object entity has a media server account; and
displaying the media data on the mobile device.

14. The non-transitory computer readable medium of claim 13, wherein, prior to receiving the media data, receiving an object entity selection by a user of the mobile device.

15. The non-transitory computer readable medium of claim 13, wherein the media data is displayed in an aggregated format, the aggregated format grouping media data associated with the object entity.

16. The non-transitory computer readable medium of claim 13, further comprising sending a pull notification from the mobile device to the home server, wherein the receiving step occurs in response to the pull notification.

17. The non-transitory computer readable medium of claim 13, further comprising instructions of:
receiving registration data received from a user of the mobile device; and
providing the registration data to the home server.
